(19) United States
(12) Patent Application Publication
(10) Pub. No.: US 2007/0142525 A1
(43) Pub. Date: Jun. 21, 2007

(54) Low TCR polymeric resistors based on reduced metal oxide conductive phase systems

(76) Inventors: Nyrissa S. Rogado, Wilmington, DE (US); Munirpallam Appadorai Subramanian, Kennett Square, PA (US); Jerome David Smith, Cary, NC (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/303,600

(22) Filed: Dec. 16, 2005

(51) Int. Cl. C09D 5/08

(52) U.S. Cl. 524/406

(57) ABSTRACT

Provided is a composition comprising 20 to 60 weight % of a reduced oxide of a metal selected from the group consisting of Mo, Nb, Cr and Ti, 1 to 9 weight % of a carbon allotrope and a polymer binder. A process for making a polymeric resistor having low temperature of resistance comprising mixing a polymer binder with the provided composition.

### FIELD OF THE INVENTION

This invention provides compositions of reduced metal oxides useful in the printing of electronic device resistors that have low temperature coefficients of resistance.

### BACKGROUND OF THE INVENTION

The demand for high-density and high-speed performance in smaller, more portable electronic devices is ever increasing. Embedded passives comprise a type of Printed Circuit Board (PCB) design that combines better performance in smaller boards with increased functionality by burying resistors or capacitors, i.e. passive devices, in the substrate material itself.

In particular, important performance requirements for making PCBs having embedded resistors operating in the 100 Ohms to 1 mega-Ohm range include a balanced Temperature Coefficient of Resistance [“TCR”] and resistive stability. However, new materials are required since current materials satisfy neither the performance nor fabrication requirements for routine manufacture of embedded passives in PCBs.

Previously, most low TCR resistors consisted of lead- and/or ruthenium-based materials as conductive fillers. Governmental regulations spurred by environmental concerns are eliminating lead from electronic devices, whereas ruthenium is too costly a precious metal for use in high performance resistors. To compensate, current resistors use graphite and metal powders, which are sufficient only for the low resistance range, that is, less than 100 Ohms, and therefore do not achieve the desired resistance operating range. Moreover, those resistors having only graphite as conductive filler tend to have large, negative TCRs in the high resistance range. Neither kind of resistor is satisfactory in performance or material.

Namura et al (U.S. Pat. No. 5,549,849) describe material containing carbon black and graphite particles, spherical metal particles, a fully oxidized metal and/or a metal salt, and a binder material. The material disclosed therein has a different valence state in the metal and consequently does not provide a resistor having a low TCR.

Moritani et al. (JP 200329023) describe pastes giving resistors with low temperature coefficients by curing at relatively low temperature, which contain polymers, electroconductive metal oxides and insulators.

Accordingly, a low TCR, lead-free, non-ruthenium conductive material is needed for the fabrication of high performance and cost-competitive electronic products.

### SUMMARY OF THE INVENTION

The invention described herein includes compositions useful as a low TCR, lead-free, non-ruthenium conductive material, comprising:
a) about 20 to about 60 weight % of a reduced oxide of a metal selected from the group consisting of Mo, Nb, Cr and Ti;
b) about 1 to about 9 weight % of a carbon allotrope; and
c) a polymer binder.

The invention described herein also includes a process for making the described compositions as well as a polymeric resistor comprising these.

### DETAILED DESCRIPTION

Definitions

A used herein, a “reduced oxide of a metal” or “reduced metallic oxide” refers to a compound having the chemical formula Mₓ^{m+}O_{y} where M pertains to the elements Mo, Nb, Ti, or Cr and their mixtures. The total formal oxidation state, m+, is greater than zero and less than 6 for Mo and Cr or less than 5 for Nb or less than 4 for Ti. The value of y is (m+)/2.

As used herein, “carbon allotrope” includes graphite or carbon black (or amorphous carbon).

As used herein, “low temperature coefficient of resistance” refers to a change in resistance with increasing or decreasing temperature equivalent to 0±500 ppm/° C.

As used herein,“inert filler” refers to talc, quartz, alumina and mixtures of these.

As used herein, an “FR4 substrate” is a laminate material produced from glass-woven fabric impregnated with an epoxy resin binder and subjected under high pressure to form sheets.

Abbreviations

Mo Molybdenum
Nb Niobium
Cr Chromium
Ti Titanium
TCR Temperature Coefficient of Resistance
PCB Printed Circuit Board
CV Coefficient of Variance
DSDA bis (3,4-dicarboxyphenyl) sulfoxide dianhydride
TFMB 4,4′-diamino-2,2′-bis(trifluoromethyl)biphenyl
HAB 3,3′-dihydroxy-4,4′-diaminobiphenyl
ESD electrostatic discharge
SEM Scanning Electron Microscope
6-FDA 2,2-bis-(3,4-dicarboxyphenyl) 1,1,1,3,3,3-hexafluoropropane dianhydride
6F-AP 2,2-bis-(3-amino-4-hydroxyphenyl) hexafluoropropane

The compositions described herein are useful as a new material for making low TCR polymeric resistors employed especially as embedded passives in a PCB. Offering a compromise between size, cost and performance of electronic devices, embedded passive devices are buried in the substrate material of the PCB, rather than mounted on the surface of the board. Thus, the passives take up no “real estate” on the board surface, enabling a smaller-sized PCB. Importantly, in lying directly underneath the integrated circuit, an embedded passive has shorter leads and lower inductance, which results in improved electrical performance. Plus, embedded passives have no solder joints, resulting in greater reliability and reduced amounts of lead.

An embedded resistor composition requires a lead-free composition owing to environmental concerns and a ruthenium-free composition owing to cost considerations. Fabrication of the embedded resistors should also be compatible with existing PCB processes, e.g., they can be made into screen printable pastes using established solvents. Other required properties include good adhesion to copper and dielectric substrates and prepreg lamination stability. Performance targets for resistors in the 100 Ohms to 1 mega-Ohm range include balanced Temperature Coefficient of Resistance, that is, less than ±500 ppm/° C., and resistive stability, that is, less than 5% drift, with thermal cycling, electrostatic discharge (ESD) and 85/85 tests.

The compositions described herein satisfy the requirements in that they comprise a certain reduced metallic oxide and a carbon allotrope, such as graphite. These are added to a polymer matrix to form a resistive paste cured at low temperatures, typically less than 250° C. Such temperatures are used because reduced metallic oxides are unstable in air at high temperatures, such as, greater than 400° C. Thus, because of the lower curing temperature, these metallic oxide compositions become suitable as conductive fillers in polymeric resistors.

Also satisfying the above performance requirements, these compositions exhibit a low temperature coefficient of resistance and stable resistive properties. Polymeric resistors comprised of these compositions in turn perform reliably when embedded in PCBs.

Composition

In these compositions, a polymer matrix is mixed with a carbon allotrope, such as graphite or carbon black, comprising about 1 to about 9% by weight of the composition and with a conductive reduced oxide of a metal comprising about 20 to 60% by weight of the composition.

The metal oxide has the formula Mₓ^{m+}O_{y}. The metals used herein include molybdenum [“Mo”], niobium [“Nb”], titanium [“Ti”], or chromium [“Cr”] and mixtures of these. If a mixture of metal ions is used, the least abundant metal ion is present at a concentration greater than 0.001 atomic percent. The total formal oxidation state m+is greater than zero and less than 6 for Mo and Cr or less than 5 for Nb or less than 4 for Ti, and the value of y is (m+)/2. These reduced metal oxides exhibit higher electrical conductivity as compared to their more fully oxidized counterparts. A particularly useful reduced metal oxide in these compositions is MoO₂and is the preferred material to use as a conductive filler

The polymer matrix includes, but is not limited to, crosslinkable, low moisture-absorbing polymers that are soluble in conventional screen-printing paste solvents. Examples of suitable matrix polymers include polyimides, epoxy-containing polyimides, polynorbornenes, epoxy-containing polynorbornenes, phenoxy resins, polyarylates, polysulfones, polyhydroxystyrenes, and polycarbonates. To the composition may optionally be added an inert inorganic filler, such as alumina, talc or quartz (or combinations of these), commercially available at least from Aldrich and comprising about 10 to about 20% by weight of the composition.

Process

The resulting paste undergoes 3-roll milling until a fineness of grind [“FOG”] of about 5 to about 7 microns is obtained. The paste is printed using a 180- or 230-mesh screen on an FR4 substrate with Copper [“Cu”] terminations. The paste is cured at about 170° C. for about 1 hour followed by a heat bump at about 230° C. for between one and ten minutes, preferably two minutes.

### EXAMPLES

Experimental Procedure

On all samples, resistance and TCR are measured, followed by 85/85, thermal cycling and ESD tests. Resistance measurements at room temperature are performed using a two-probe method with a Keithley meter. The coefficient of variance [“CV”] is calculated as a measure of resistance reproducibility. The TCR is obtained from the difference in the measured resistances at 125° C. and at room temperature (HTCR) and the difference in the measured resistances at room temperature and at −55° C. (CTCR). The 85/85 test, also known as the high pressure cooker test, is an aging test performed by exposing the resistors to environmental conditions at 85° C. and 85% relative humidity for 100 hours. The thermal cycling test is done by putting the resistors through 60 cycles of changing temperature between −25°C. and 125° C. The ESD test is conducted by applying a 2000 V pulse through the resistor. The resistors typically exhibit very small change in resistance following these tests.

Both commercially available and synthesized metallic oxides can be used as conductive fillers. Commercially available powders to be incorporated into compositions described herein may be purchased from suppliers, such as Aldrich, Fisher, and Alfa. One way of preparing a conductive reduced metallic oxide in the laboratory is described as follows. The synthesis of MoO₂ is used as an example. A 0.25 M sodium molybdate solution [“Na₂MoO₄”] is prepared by dissolving in water. Concentrated hydrochloric acid (reagent grade) is added to keep pH=1. An equal volume of 2.6 M sodium borohydride [“NaBH₄”] is slowly added to the solution. Ammonium hydroxide is then added to the mixture to neutralize the solution to pH 7. The resulting precipitate is filtered, washed and dried. The dried precipitate is placed in an alumina crucible and inserted into a quartz reactor. The powder is calcined at 450° C. for 12 hours under nitrogen flow. The samples may be furnace cooled to room temperature. Analysis of samples using powder X-ray diffraction typically show broad peaks corresponding to the reduced molybdenum oxide MoO₂ phase.

### Examples 1-8

Table 1 is a chart of the measured resistances at room temperature and TCRs between −55° C. [CTCR] and 125° C. [HTCR] for selected resistor compositions. Inert fillers such as talc, quartz or alumina have also been added but are not specifically indicated in the composition.

Polymer 1 refers to a proprietary crosslinked polyimide consisting of bis (3,4-dicarboxyphenyl) sulfoxide dianhydride [“DSDA”], phthalic anhydride, 4,4′-diamino-2,2′-bis(trifluoromethyl)biphenyl [“TFMB”], and 3,3′-dihydroxy4,4′-diaminobiphenyl [“HAB”]. This material and its synthesis are described in US 2005/0154181, hereby incorporated herein by reference.

Polymer 2 is a proprietary fluorinated crosslinked polyimide consisting of 2,2-bis-(3,4-dicarboxyphenyl) 1,1,1,3,3,3,-hexafluoropropane dianhydride [“6-FDA”], phthalic anhydride, TFMB, and 2,2-bis-(3-amino-4-hydroxyphenyl)hexafluoropropane [“6F-AP”]. Polymer 2 also contains an epoxy, RSS-1407 from Resolution Performance Products, and N,N-dimethylbenzylamine as catalyst. This material and its synthesis are described in U.S. patent application Ser. No. 11/248803, hereby incorporated herein by reference.

TABLE 1

| Example | | | | | HTCR | CTCR |
|---|---|---|---|---|---|---|
| No. | Composition | Weight % | R Ohms | CV % | ppm/° C. | ppm/° C. |
| 1 | MoO₂ (Alfa)/polymer 1 | 66.88/17.04 | 197 | 11.2 | 1035 | 842 |
| 2 | Graphite/polymer 1 | 41.52/30.08 | 1,430 | 5.5 | 166 | −332 |
| 3 | MoO₂ (Alfa): | 62.78: | 724 | 4.9 | 120 | −153 |
| | Graphite/polymer 1 | 2.54/17.84 | | | | |
| 4 | MoO₂ (Alfa): | 40: | 252 | 9.6 | 628 | 495 |
| | Graphite/polymer 2 | 1.39/49.33 | | | | |
| 5 | MoO₂ (Alfa): | 32.12: | 283 | 3.3 | −44 | −90 |
| | Carbon black/polymer 2 | 3.06/49.52 | | | | |
| 6 | MoO₂ (Alfa): | 32.50: | 251 | 2.9 | −9 | −43 |
| | Carbon black/polymer 2 | 3.06/49.58 | | | | |
| 7 | Ground MoO₂ (Alfa): | 40: | 107 | 9 | N/A | N/A |
| | Graphite/polymer 2 | 1.39/49.33 | | | | |
| 8 | Lab-synthesized MoO₂: | 40: | 90 | 5.9 | N/A | N/A |
| | Graphite/polymer 2 | 1.39/49.33 | | | | |

The compositions described herein have a higher resistance and lower TCR than when the conductive metallic oxides are mixed alone with the polymer without any carbon particles added to it.

Example 1 shows the composition and resistance properties for a polyimide containing 66.88% by weight of MoO₂ and 17.04% by weight of the polyimide. This composition yields a 197 Ohm-resistor with HTCR of 1035 ppm/° C. and CTCR of 842 ppm/° C. These values of TCR are generally considered too large.

Example 3 shows that when 2.54% graphite is added together with 62.78% MoO₂, the resistance of the polyimide-based resistor increases from 197 to 724 Ohms, which is accompanied by a decrease in HTCR from 1035 to 120 ppm/° C. and a decrease in CTCR from 842 to -153 ppm/° C. Furthermore, addition of graphite decreases the CV from 11.2% to 4.9%.

Example 2 shows that a polymeric resistor composition containing graphite alone does not show the same enhancement of resistance properties.

It has also been found that substitution of graphite with carbon black results in further improvement of the resistor properties. Using another polyimide as the polymer matrix, Example 4 shows that a conductive phase comprising 40% MoO₂ (from a commercial source) and 1.39% graphite gives resistance of 252 Ohms, HTCR of 628 ppm/° C., and CTCR of 495 ppm/° C.

Example 6 shows that another 250-Ohm resistor composition comprising 32.5% MoO₂ and 3.06% carbon black gives a much lower HTCR and CTCR, −9 and —43 ppm/° C., respectively. The CV has also decreased from 9.6% to 2.9% with carbon black substitution. ESD tests on this sample result in less than 5% change in the resistance.

The particle size and morphology of the conductive fillers are also shown to affect the resistor properties. SEM analysis of the MoO₂ powder from Alfa shows that the particle sizes are not homogeneous, ranging from 200 nm to 100 μm. As previously noted in Example 4, a resistor composition made from 40% of this starting material and 1.39% graphite gives a resistance of 252 Ohms and a CV of 9.6%. The MoO₂ powder from Alfa was ground for 4 hours under N₂ atmosphere, which resulted in a more homogenous distribution of particle sizes of 200 to 400 nm. This ground powder was used to prepare a paste of the same composition as above, which exhibits a much smaller resistance of 107 Ohms with a slightly lower CV of 9% (example 7). A similar resistor paste composition was also prepared using lab-synthesized (as described above) MoO₂. SEM analysis of this sample shows that it consists of 3-dimensional star-shaped particles whereas the commercially available samples have more spherical particles. The particles from the lab-synthesized MoO₂ samples are slightly smaller than the commercially available samples, approximately 200 nm in size. Example 8 that resistors made from this MoO₂ gives a resistance of 90 Ohms with a much smaller CV of 5.9%.

What is claimed is:

1. A composition comprising:
a) about 20 to about 60 weight % of a reduced oxide of a metal selected from the group consisting of molybdenum, niobium, chromium and titanium;
b) about 1 to about 9 weight % of a carbon allotrope; and
c) a polymer binder.

2. The composition of claim 1, wherein the carbon allotrope is carbon black.

3. The composition of claim 1, wherein the carbon allotrope is graphite.

4. The composition of claim 1, wherein the polymer binder is selected from the group consisting of polyimides, epoxy-containing polyimides, polynorbornenes, epoxy-containing polynorbornenes, phenoxy resins, polyarylates, polysulfones, polyhydroxystyrenes, and polycarbonates.

5. The composition of claim 4, wherein the carbon allotrope is carbon black.

6. The composition of claim 1, further comprising about 10 to about 20 weight % of an inert inorganic filler.

7. The composition of claim 2, further comprising about 10 to about 20 weight % of an inert inorganic filler.

8. The composition of claim 3, further comprising about 10 to about 20 weight % of an inert inorganic filler.

9. The composition of claim 4, further comprising about 10 to about 20 weight % of an inert inorganic filler.

10. The composition of claim 5, further comprising about 10 to about 20 weight % of an inert inorganic filler.

11. A process for making a polymeric resistor having low temperature coefficient of resistance, the process comprising:
a) providing a polymer binder selected from the group consisting of polyimides, epoxy-containing polyimides, polynorbornenes, epoxy-containing polynorbornenes, phenoxy resins, polyarylates, polysulfones, polyhydroxystyrenes, and polycarbonates;
b) mixing the polymer with a reduced oxide of a metal selected from the group consisting of molybdenum, niobium, chromium and titanium and a carbon allotrope to result in a composition, wherein the metallic oxide comprises about 20 to about 60 weight % of the composition and the carbon allotrope comprises about 1 to about 9 weight % of the composition;
c) optionally, adding an inert filler, wherein the inert filler comprises about 10 to about 20 weight % of the composition.

12. The process of claim 11, further comprising the steps of:
d) three-roll milling the composition to obtain a fineness of grind of about 5 to about 7 microns;
e) printing the milled composition using a 180- or 230-mesh screen on an FR4 substrate having Copper terminations;
f) curing the printed composition at about 170° C. for about 1 hour; g) increasing the curing temperature to about 230° C. for between one and ten minutes.

13. A polymeric resistor having a low temperature coefficient of resistance comprising the composition of claim 1.

14. A polymeric resistor having a low temperature coefficient of resistance comprising the composition of claim 5.
